(19) United States
(12) Patent Application Publication
(10) Pub. No.: US 2008/0083864 A1
(43) Pub. Date: Apr. 10, 2008

(54) Holder

(76) Inventor: Ryan D. Davis, Loa, UT (US)

Correspondence Address: QUARLES & BRADY LLP, ONE SOUTH CHURCH AVENUE, SUITE 1700, TUCSON, AZ, 85701-1621, US

(21) Appl. No.: 11/538,789

(22) Filed: Oct. 4, 2006

(51) Int. Cl. B42F 13/00

(52) U.S. Cl. 248/339

(57) ABSTRACT

A carabiner or hook is formed with a screw which enables the carabiner or hook to be mounted on a surface.

### BACKGROUND OF THE INVENTION

1. Field of the Invention

The invention relates to an article on which items can be suspended or to which items can be anchored.

2. Description of the Prior Art

Snap hooks, carabiners and similar holders are used to hold diverse items. For instance, carabiners are employed as key holders and are also used in mountain climbing as holders or anchors for ropes. Depending upon the application, a holder such as a snap hook or carabiner is used by itself or is mounted on an object which then serves as a support for the holder.

When mounting a holder of the above type on an object which is to serve as a support for the holder, the holder can be mounted on the supporting object directly. An item which is to be held or anchored can then be connected to the holder and the holder now functions as a link between the item and the supporting object. The holder can also be mounted on a supporting object indirectly such as, for example, by way of a ring. Here, the ring is mounted on the supporting object and the holder is connected to the ring so that the ring functions as a link between the supporting object and the holder. An item which is to be held or anchored is thereupon connected to the holder.

It can be seen that a relatively simple replacement for a supporting object would be desirable.

### SUMMARY OF THE INVENTION

One aspect of the invention resides in a holder comprising a holding member for holding articles. The holding member includes a first section and a second section relatively movable between a first position and a second position. The first section and second section cooperate in the first position to define an opening and a substantially uninterrupted periphery circumscribing the opening. The periphery has a gap in the second position to permit connection of an article to the holding member. The holder further comprises a threaded member for mounting the holding member on objects, and the threaded member is permanently connected to the first section or second section of the holding member. By way of example, the holding member can be in the form of a snap hook or carabiner.

The threaded member may include a rod and such rod is preferably straight. The threaded member is advantageously rigid with the section of the holding member to which the threaded member is connected, and it is preferred for the threaded member to be provided with external threads. The threaded member can be coplanar with the holding member in the first position of the first section and second section of the holding member.

In the uninterrupted condition of the periphery formed by the first section and second section of the holding member, the periphery may be elongated and have opposite longitudinal ends. Under such circumstances, the threaded member is advantageously located at one of these ends. The periphery can be approximately oval, for example, in the uninterrupted condition thereof.

Another aspect of the invention resides in a method of connecting an article and a holder for the article. The holder has an opening and a periphery capable of assuming a first condition and a second condition. The periphery is substantially uninterrupted and circumscribes the opening in the first condition, and the periphery has a gap in the second condition. The method comprises the steps of screwing the holder into a surface, converting the periphery of the holder from one of its conditions to the other, and passing part of the article to be connected to the holder through the gap present in the second condition of the periphery.

Additional features and advantages of the invention will be forthcoming from the following detailed description of certain preferred embodiments when read in conjunction with the accompanying drawings.

### BRIEF DESCRIPTION OF THE DRAWINGS

FIG. 1 is a plan view of one embodiment of a holder in accordance with the invention in a closed condition and shows a sign carried by the holder and an object on which the holder is to be mounted.

FIG. 2 is a plan view of the holder of FIG. 1 in an open condition.

FIG. 3 is a plan view of another embodiment of a holder according to the invention in a closed condition.

### DESCRIPTION OF THE PREFERRED EMBODIMENTS

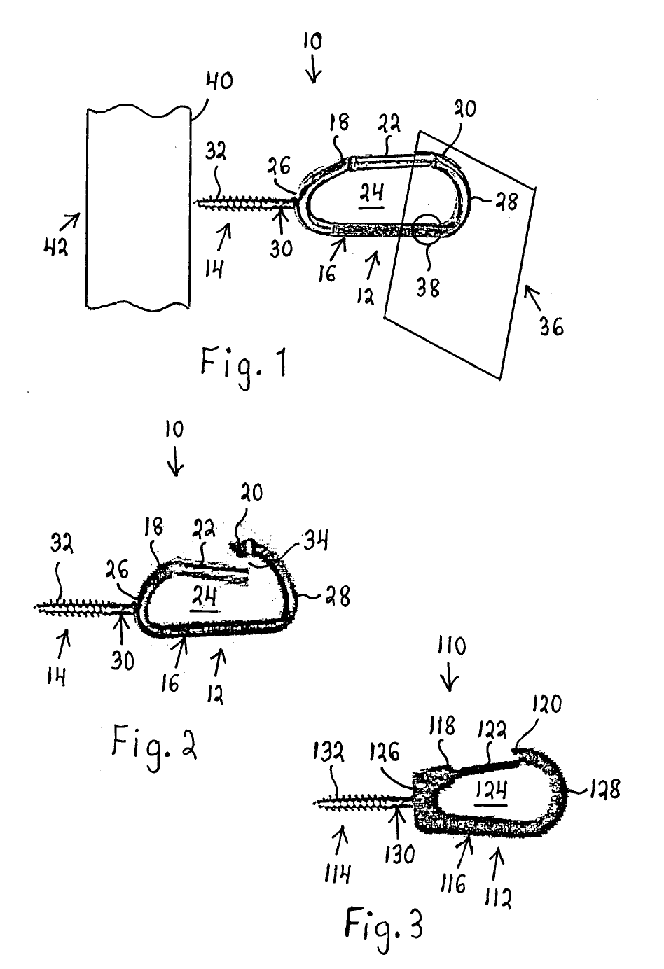

Referring to FIGS. 1 and 2, the numeral 10 identifies a holder or anchor in accordance with the invention. The holder 10 comprises a holding member 12 and a threaded member 14 for mounting the holding member 12 on a surface. The threaded member 14 is permanently connected to the holding member 12.

The holding member 12, which is here a carabiner, includes an approximately C-shaped carrier or main section 16 having two ends 18 and 20 which are spaced from one another. The holding member 12 further includes a straight gate or auxiliary section 22, and the gate 22 has an attached end which is pivotally connected to the end 18 of the carrier 16. The gate 22 further has a laterally shiftable end, and the end 20 of the carrier 16 and laterally shiftable end of the gate 22 are provided with cooperating coupling portions which enable the laterally shiftable end of the gate 22 to firmly but releasably engage the end 20 of the carrier 16, e.g., frictionally.

The carrier 16 and gate 22 are pivotal relative to one another between a position in which the carabiner 12 is closed and a position in which the carabiner 12 is open. The closed condition of the carabiner 12 is shown in FIG. 1 while the open condition is shown in FIG. 2.

In the closed condition of the carabiner 12, the gate 22 bridges the ends 18,20 of the carrier 16. The carrier 16 and gate 22 cooperate to define a central opening 24 which is circumscribed, or completely surrounded circumferentially, by an uninterrupted or continuous loop or periphery made up of the carrier 16 and the gate 22. The laterally shiftable end of the gate 22 is coupled to the end 20 of the carrier 16 to prevent unintentional opening of the carabiner 12.

The loop 16,22 and central opening 24 are elongated in the closed condition of the carabiner 12 and preferably have an oval or approximately oval configuration as illustrated. The elongated loop 16,22 has opposite longitudinal ends 26 and 28, and the threaded member 14 is attached to the longitudinal end 26 of the loop 16,22.

The longitudinal end 26 of the loop 16,22 is situated on the carrier 16, and the threaded member 14 comprises a straight rod or shaft 30 having an end which is rigid with the longitudinal end 26 of the loop 16,22. The rod 30 is disposed externally of the loop 16,22 and projects from the loop 16,22 in a direction away from the central opening 24. The rod 30 has a pointed, free end remote from the carrier 16, and the rod 30 is formed with external threads 32 which extend from the region of the free end of the rod 30 along at least the major part of the length of the rod 30. The threaded member 14 can be referred to as a screw.

The carrier 16 and gate 22 define a plane in the closed condition as well as the open condition of the carabiner 12, and the threaded rod 30 is located in this plane.

In the open condition of the carabiner 12 shown in FIG. 2, the laterally shiftable end of the gate 22 has been uncoupled from the end 20 of the carrier 16. The gate 22 has been pivoted relative to the carrier 16 such that the laterally shiftable end of the gate 22 is displaced from the end 20 of the carrier 16 into the central opening 24. The carrier 16 and the gate 22 define a gap 34 in the loop 16,22 which is now interrupted or discontinuous. The gap 34 makes it possible to connect or anchor an item to the carabiner 12 by passing a portion of the item through the gap 34.

FIG. 1 illustrates an item or article 36 connected to the carabiner 12. The item 36, which is here in the form of a sign, is provided with an aperture 38 which receives the carrier 16 to thereby establish a connection between the carabiner 12 and the sign 36.

One way of using the holder 10 is as follows:

The carabiner 12 is grasped with a hand and the pointed end of the screw 14 placed against a surface 40 of an object 42, e.g., a post, as shown in FIG. 1. The carabiner 12 is thereupon mounted on the surface 40 by rotating the carabiner 12 so that the screw 14 is screwed into the object 40.

Assuming that the carabiner 12 is in its closed condition, the carabiner 12 is opened once the carabiner 12 has been affixed to the surface 40. In the open condition of the carabiner 12, the end 20 of the carrier 16 is separated from the gate 22 by the gap 34 and is accessible. The sign 36 is now mounted on the carabiner 12 by causing the end 20 of the carrier 16 to pass through the aperture 38 of the sign 36. As the end 20 passes through the aperture 38, a portion of the sign 36 adjoining the aperture 38 passes through the gap 34 between the carrier 16 and the gate 22 and enters the central opening 24 of the carabiner 12. As a result, a connection is established between the carabiner 12 and the sign 36.

The carabiner 12 is closed after the end 20 of the carrier 16 has passed through the aperture 38 of the sign 36, and the sign 36 can then be suspended from the carabiner 12.

FIG. 3 illustrates another embodiment of a holder according to the invention. In FIG. 3, the same numerals as in FIG. 1, plus 100, are used to identify similar elements.

The main distinction between the holder 10 of FIG.1 and the holder 110 of FIG. 3 is that the holder 110 employs a snap hook 112 instead of the carabiner 12. The carabiner 12 and the snap hook 112 differ primarily in the design of the respective gates 22 and 122. The gate 122 of the snap hook 112 is resiliently biased to a position in which the snap hook 112 is closed, that is, the gate 122 automatically returns to a position in which the snap hook 112 is closed when the gate 122 is released while in a position in which the snap hook 112 is open. In contrast, the gate 22 of the carabiner 12 remains in a position in which the carabiner 12 is open when the gate 22 is released following movement of the gate 22 to such position.

The snap hook 112 is in a closed condition in FIG. 3.

The holders 10,110 can be used in different ways. Thus, as illustrated in FIG. 1, the holders 10,110 can be used to suspend items such as signs and planters. It is further possible to anchor an item by securing a holder 10,110 to an object and attaching the item to the holder 10,110 via a rope or cable. These applications of the holders 10,110 are given by way of example and not by way of limitation since a variety of other applications exist within the scope of the invention.

Various modifications of the holders 10,110 are possible within the meaning and range of equivalence of the appended claims.

I claim:

1. A holder comprising:
a holding member for holding articles, said holding member including a first section and a second section relatively movable between a first position and a second position, and said first section and said second section cooperating in said first position to define an opening and a substantially uninterrupted periphery circumscribing said opening, said periphery having a gap in said second position to permit connection of an article to said holding member; and
a threaded member for mounting said holding member on objects, said threaded member being permanently connected to one of said sections.

2. The holder of claim 1, wherein said holding member comprises a snap hook.

3. The holder of claim 1, wherein said holding member comprises a carabiner.

4. The holder of claim 1, wherein said holding member and said threaded member are substantially coplanar in said first position of said first section and said second section.

5. The holder of claim 1, wherein said threaded member is rigid with said one section.

6. The holder of claim 1, wherein said threaded member comprises a rod.

7. The holder of claim 1, wherein said threaded member is provided with external threads.

8. The holder of claim 1, wherein said periphery is approximately oval in said first position of said first section and said second section.

9. The holder of claim 1, wherein said periphery is elongated and has opposed longitudinal ends in said first position of said first section and said second section, said threaded member being located at one of said ends.

10. The holder of claim 9, wherein said threaded member comprises a substantially straight rod rigid with said one section, said holding member and said rod being substantially coplanar in said first position of said first section and said second section.

11. A method of connecting an article and a holder for the article, said method comprising the steps of:
screwing said holder into a surface, said holder having an opening and a periphery capable of assuming a first condition and a second condition, said periphery being substantially uninterrupted and circumscribing said opening in said first condition, and said periphery having a gap in said second condition;
converting said periphery from one of said conditions to the other; and
passing part of said article through said gap in said second condition of said periphery to establish a connection between said article and said holder.
